(19) United States
(12) Patent Application Publication
(10) Pub. No.: US 2010/0169158 A1
(43) Pub. Date: Jul. 1, 2010

(54) SQUASHED MATRIX FACTORIZATION FOR MODELING INCOMPLETE DYADIC DATA

(75) Inventors: Deepak K. AGARWAL, Sunnyvale, CA (US); Srujana Merugu, Sunnyvale, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/346,641

(22) Filed: Dec. 30, 2008

(51) Int. Cl. G06N 5/02; G06Q 10/00

(52) U.S. Cl. 705/10; 706/52

(57) ABSTRACT

A method of predicting a response relationship between elements of two sets includes: specifying a dyadic response matrix; specifying covariates that measure additional dyadic relationships; specifying a number of row clusters and a number of column clusters for clustering the rows and columns of the response matrix; specifying a rank for cluster factors that model average interactions between row clusters and column clusters by products of cluster factors; and determining prediction parameters for predicting responses between elements of the first set and the second set by improving a likelihood value that relates the prediction parameters to the response matrix, the covariates, the observation weights, the row clusters and the column clusters. Determining the prediction parameters includes: updating the prediction parameters for fixed assignments of row clusters and column clusters, and updating assignments for row clusters and column clusters for fixed prediction parameters.

### BACKGROUND OF THE INVENTION

1. Field of Invention

The present invention relates to predictive modeling generally and more particularly to predictive modeling with incomplete dyadic data.

2. Description of Related Art

Predictive modeling for dyadic data is an important data mining problem encountered in several domains such as social networks, recommendation systems, internet advertising, etc. Such problems involve measurements on dyads, which are pairs of elements from two different sets. Often, a response variable yᵢⱼ attached to dyads (i, j) measures interactions among elements in these two sets. Frequently, accompanying these response measurements are vectors of covariates xᵢⱼ that provide additional information which may help in predicting the response. These covariates could be specific to individual elements in the sets or to pairs from the two sets.

It is also tempting to construe this as yet another matrix approximation problem (after appropriate normalization for the effect of covariates) with the dyadic sets forming the rows and columns of the response matrix. However, these problems have characteristics that makes usual matrix approximation algorithms ineffective. First, the data matrices obtained are extremely high dimensional with millions of rows and columns, which makes it infeasible to adopt computationally intensive approaches. Secondly, the matrices are highly incomplete with response values available only for a small fraction (typically 0.1-5%) of all possible dyads. There is also high variability in the number of entries per row/column, which makes usual matrix notions such as row space, column space, rank, etc., non applicable. Thus, in most large scale applications, data sparsity, curse of dimensionality (i.e., large number of dyads), low signal-to-noise ratio and heterogeneity makes statistical modeling a challenging task.

As one particular real-world example, consider an online movie recommendation application such as NetFlix, which involves predicting preference ratings of users for movies. This preference rating can be viewed as a dyadic response variable yᵢⱼ; it depends both on the user i and the movie j and captures interactions that exist among users and movies. Since both user and movie sets are large, the number of possible dyads is astronomical. However, most users rate only a small subset of movies, hence measurements (actual ratings provided by a user) are available only for a small fraction of possible dyads.

In addition to the known user-movie ratings, there also exists other predictive information such as demographic information about users, movie content and other indicators of user-movie interactions, e.g., is the user's favorite actor part of the movie cast? These predictive factors can be represented as a vector of covariates xᵢⱼ associated with user-movie dyad (i, j). Incorporating covariate information in the predictive model may improve performance in practice. It is also often the case that some latent unmeasured characteristics that are not captured by these covariates induce a local structure in our dyadic space (e.g., spatial correlations induced due to cultural similarities). In this context, it is, therefore, essential to account for such local structures along with information in the covariates in order to obtain high quality predictions.

The predictive problem discussed above is not specific to movie recommendation systems and arises in several other contexts (e.g., click rate estimation for webpage-ad dyads in internet advertising, estimating probabilities of a call between telephone dyads in telecommunication networks, etc.) Prior work provide solutions using both supervised and unsupervised learning approaches. The supervised learning approach involves building a regression or a classification model to predict the dyadic response yᵢⱼ solely as a function of the available covariates xᵢⱼ. It has been well-studied with considerable literature on selecting informative covariates and obtaining bounds on the generalization error. However, in general, this approach disregards any local structure that might be induced on the dyadic space due to other latent unmeasured factors.

In contrast, the unsupervised approach focuses exclusively on capturing local structure in the response measurements on dyads. The discovered latent structures (e.g., clusters, principal components) provide insights about the interactions in the dyadic space which are useful in the absence of informative covariates. In fact, these local structures provide a parsimonious model for succinctly capturing the interactions in the dyadic matrix. However, since this approach does not adjust for the effect of covariates, the resulting latent structure may contain redundant information.

Thus, there is a need for improved methods for predicting dyadic responses from incomplete data sets.

### SUMMARY OF THE INVENTION

In one embodiment of the present invention, a method of predicting a response relationship between elements of two sets, includes: specifying a response matrix that measures a response relationship between elements of a first set corresponding to rows of the response matrix and a second set corresponding to columns of the response matrix; specifying covariates that measure additional relationships between elements of the first set and the second set; specifying observation weights for weighing measurements for elements of the first set and the second set; specifying a number of row clusters for clustering elements of the first set into row clusters; specifying a number of column clusters for clustering elements of the second set into column clusters; specifying a rank for cluster factors that model average interactions between row clusters and column clusters by products of cluster factors; and determining prediction parameters for predicting responses between elements of the first set and the second set by improving a likelihood value that relates the prediction parameters to the response matrix, the covariates, the observation weights, the row clusters and the column clusters. Determining the prediction parameters includes: updating the prediction parameters for fixed assignments of row clusters and column clusters, and updating assignments for row clusters and column clusters for fixed prediction parameters.

According to one aspect of this embodiment, one or more values for the prediction parameters can be saved in a computer-readable medium. For example, values for prediction parameters can be saved directly or through some related characterization in memory (e.g., RAM (Random Access Memory)) or permanent storage (e.g., a hard-disk system).

According to another aspect, one of the sets may corresponds to consumer choices for goods or services, another of the sets corresponds to individual consumers, and the response matrix corresponds to preferences of the individual consumers for the consumer choices.

According to another aspect, the observation weights may be scaled to indicate a presence or an absence of values for the response matrix for specific combinations of rows and columns of the response matrix.

According to another aspect, improving the likelihood value may correspond to fitting the parameters to the response matrix through a family of probability distributions for predicting the response matrix.

According to another aspect, the prediction parameters may include mixture prior probabilities for assigning rows and columns to row clusters and column clusters.

According to another aspect, the prediction parameters may include regression coefficients for using combinations of the covariates to predict the response relationship between elements of the two sets.

According to another aspect, the prediction parameters may include row cluster factors and column cluster factors for using products of the row cluster factors and the column cluster factors to predict the response relationship between elements of the two sets.

According to another aspect, updating assignments for row clusters and column clusters may include calculating probability values for assigning rows and columns by using products of cluster factors to estimate effects of possible assignments.

According to another aspect, the method may further include using the prediction parameters to predict a likelihood over response values between elements of the two sets. For example, this likelihood over response values may be a probability distribution over possible response values.

Additional embodiments relate to an apparatus for carrying out any one of the above-described methods, where the apparatus includes a computer for executing instructions related to the method. For example, the computer may include a processor with memory for executing at least some of the instructions. Additionally or alternatively the computer may include circuitry or other specialized hardware for executing at least some of the instructions. Additional embodiments also relate to a computer-readable medium that stores (e.g., tangibly embodies) a computer program for carrying out any one of the above-described methods with a computer.

In these ways the present invention enables improved methods and related system for predicting dyadic responses from incomplete data sets.

### BRIEF DESCRIPTION OF THE DRAWINGS

FIG. 1 shows a method for predicting a response relationship between element of two sets according to an embodiment of the present invention.

FIG. 2 shows three exemplary exponential families of distributions plus their associated parameters and cumulant functions.

FIG. 3 shows provides exemplary canonical link functions for the exponential families shown in FIG. 2.

FIG. 4 shows an SMF-Gaussian method for predicting dyadic responses according to an embodiment of the present invention.

FIG. 5 shows root mean square errors (RMSE) for the three predictive models to illustrate an embodiment of the present invention.

FIG. 6 shows prediction accuracy values for three predictive models to illustrate an embodiment of the present invention.

FIG. 7 shows prediction accuracy values for two predictive models to illustrate an embodiment of the present invention.

FIG. 8 shows a conventional general-purpose computer.

FIG. 9 shows a conventional Internet network configuration.

### DETAILED DESCRIPTION OF EXEMPLARY EMBODIMENTS

### 1. Introduction

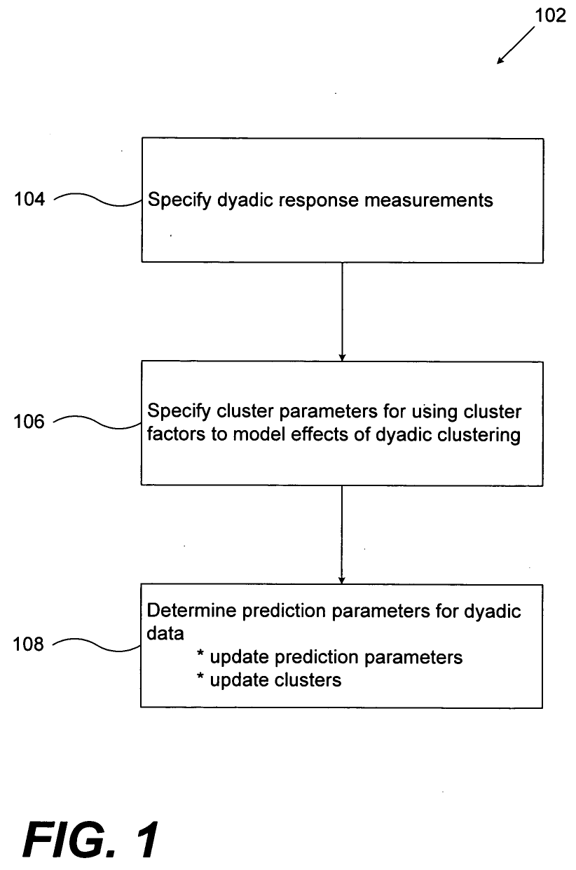

FIG. 1 shows a method 102 for predicting a response relationship between element of two sets according to an embodiment of the present invention. First, dyadic response measurements are specified for elements of the two sets 104. These measurements may include values for the response relationship being modeled as well as additional dyadic data that relates elements of the two sets. Next cluster parameters are specified for using cluster factors to model effects of dyadic clustering (e.g., grouping elements of the two sets) 106. These parameters may include weights for the measurements, numbers of allowed clusters for the two sets, and dimensions for cluster factors. Next prediction parameters are determined for predicting the response relationship between elements of the two sets 108. These prediction parameters may include statistical parameters for the underlying models, regression coefficients for fitting the measurements to the statistical models, and cluster factors for modeling the effect the clusters elements from the two sets. This determination may include an iterative process for updating the prediction parameters and updating the clusters.

As described below in detail, related embodiments of the present invention combine the benefits of both supervised and unsupervised learning approaches by simultaneously incorporating the effect of covariates as in supervised learning and also account for any local structure that may be present in the data as in unsupervised learning. To achieve this, the response is modeled as a function of both covariates (to capture global structure) and a discrete number of latent factors (to capture local structure). Referring to elements in the two sets that form the dyads as rows and columns, the model assumes that the row and column elements are separately assigned to a finite number of row and column clusters (or factors). The cross-product of these row and column clusters partition the dyadic matrix into a small number of rectangular block clusters; these provide an estimate of the latent factors. The row-column decoupling strategy provides an efficient algorithm to estimate latent structures by iteratively performing separate row and column clusterings.

In the specific case when the assignments are exclusive (i.e., “hard”) as opposed to probabilistic (i.e., “soft”), each row and column is assigned to one and only one row and column cluster respectively. This partitions the dyadic matrix into a small number of rectangular blocks or co-clusters. In this case, the covariate information and local structures are incorporated simultaneously by assuming that the mean (or some function of the mean) of the response variable is a sum of some unknown function of the covariates and a block-specific constant; both of which get estimated from the data. For models solely based on covariates, the additional block-specific constant that is extracted by the disclosed methods can be assumed to be part of the noise model; by teasing out this extra information parsimoniously through a piecewise constant function, the resulting model may lead to better generalizations in practice. Furthermore, the estimated blocks and the corresponding constants are often representative of some latent unmeasured factors that contributes to the interactions seen in our dyadic matrix. For instance, cultural preferences may cause users in a certain geographic region to provide higher ratings to certain class of movies. The clusters obtained from the disclosed methods when subjected to further analysis by domain experts may lead to the discovery of such patterns. Thus, the corresponding model is both accurate in terms of predictions and interpretable in terms of the clusters obtained.

For extremely sparse dyadic data that is often encountered in real applications, estimating block-specific constants may put restrictions on the number of estimable latent factors since there may not be enough available data to obtain reliable estimates of these constants with large number of blocks. To overcome this, block-constants can be estimated through a factorization model. As a result, certain embodiments based on a hybrid approach combine the best of low rank factorization and discrete latent factors and significantly outperforms each of the separate approaches.

Embodiments are presented below in the framework of generalized linear models (GLMs), which provides a flexible class of predictive methods based on exponential families. This class includes Gaussian, Poisson and Bernoulli distributions as special cases. Further, for this special class of statistical models, the latent factors can be modeled through an approach that is related to co-clustering using Bregman divergences. Certain embodiments employ an iterative model fitting process in the generalized expectation-maximization framework in order to find a co-clustering that provides an improved (or optimal) predictive performance after adjusting for the covariates.

Related disclosure for predictive models for incomplete dyadic data can be found in U.S. patent application Ser. No. 11/841,093, filed Aug. 20, 2007, entitled “Predictive Discrete Latent Factor Models for Large Scale Dyadic Data,” which is incorporated herein by reference in its entirety.

### 2. Preliminaries

We begin with a brief review of background material on (i) one-parameter exponential families, generalized linear regression models, and (ii) co-clustering for dyadic data.

### 2.1. Exponential Families

One-parameter exponential families provide a coherent framework to study commonly occurring prediction problems with univariate response. A random variable X with density fψ(x;θ,φ) is said to belong to a one-parameter exponential family if

fψ(x;θ,φ)=exp((θt(x)−ψ(θ))/α(φ))pₒ(x). (1)

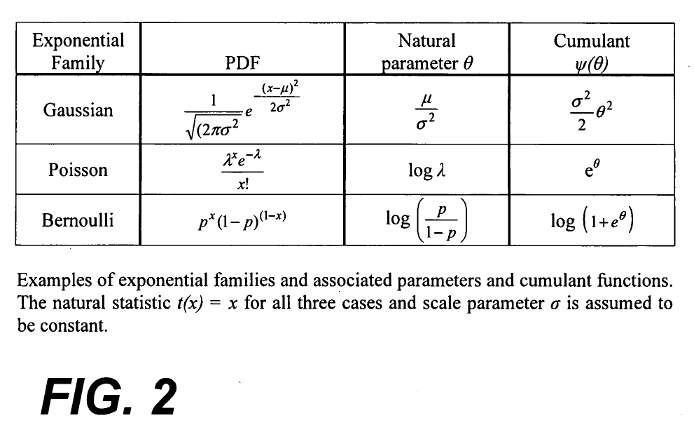

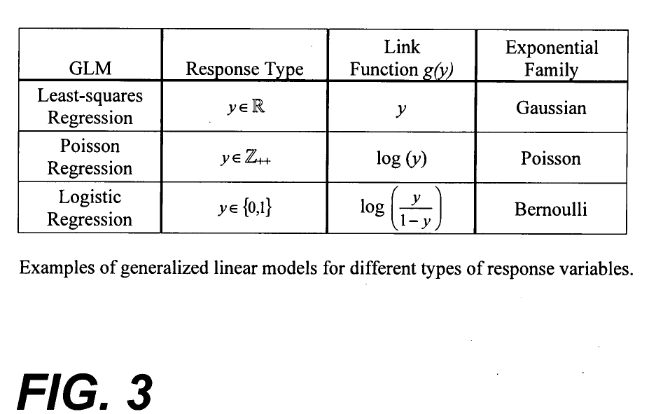

Here, the unknown parameter (also called the natural parameter) θ ∈ Θ; pₒ (x) is a probability measure that does not depend on θ; ψ(θ) is the cumulant generating function of t(X). The function α(φ) is a scalar function of a scale parameter φ. The natural statistic t(x) is some function of x (in most examples, t(x)=x). In fact, E(t(X))=ψ′(φ) and Var(t(X))=α(φ)ψ″ (φ). FIG. 2 shows three important examples of exponential families (Gaussian, Poisson, and Bernoulli) plus their associated parameters and cumulant functions.

### 2.2. Generalized Linear Models.

Generalized linear models (GLM) provides an abstract framework to study classification and regression problems that are commonly encountered in practice [3]. Least squares regression for continuous response and logistic regression for binary response are special cases. A GLM is characterized by two components.
(i) The distribution of the response variable Y belongs to a member of the exponential family as defined in eq. 1 with examples provided in FIG. 2.
(ii) The mean μ(θ)=ψ′(θ) is some unknown function of the predictor vector x, i.e., μ(θ)=g⁻¹(x; β) for some unknown vector β. The most common choice is to assume g is a function of x^{t}β. The function g which ensures that g(μ) is a linear function of the predictors is often referred to as a link function and the choice of g that ensures θ=x^{t}β is called the canonical link function. For instance, in the case of a Bernoulli distribution, g(μ)=log(μ/(1−μ)). FIG. 2 provides examples of canonical link functions for common exponential family members (Gaussian, Poisson, Bernouilli). Unless otherwise mentioned, we will only consider canonical link functions in our subsequent discussions.

Thus, if the response Y follows a GLM, the conditional density fψ(y; β^{l}x) of y given x depends on the unknown parameter β only through the linear function β^{t}x. Although predictive methods based on GLMs are in general effective, they fail to account for unobserved interactions that are often present in dyadic data after adjusting for the covariates; our method provides a solution to this problem. Before proceeding further, we provide background material on matrix co-clustering, which is related to the approach taken by disclosed embodiments that capture unaccounted interactions by performing co-clustering in a latent space through a mixture model.

### 2.3. Matrix Co-Clustering

Co-clustering, or simultaneous clustering of both rows and columns, has become a method of choice for analyzing large and sparse data matrices [1, 2] due to its scalability and has been shown to be effective for predicting missing values in dyadic data exploiting the interactions that are often present in the observed response values. In particular, the Bregman co-clustering framework [1] presents a formulation from a matrix approximation point of view, wherein the row and column clusterings are chosen so as to minimize the error between the original matrix Y and a reconstructed matrix Ŷ (called the minimum Bregman information matrix) that depends only on the co-clustering, and certain summary statistics of Y, e.g., co-cluster means. This formulation allows the approximation error to be measured as the weighted sum of element-wise Bregman divergence between the matrices Y and Ŷ. This co-clustering formulation also permits an alternate interpretation in terms of a structured mixture model [3].

For dyad (i, j), let pᵢ and γⱼ denote the row and column membership of the i^{th} row and j^{th} column respectively. We assume the cluster ids for rows and columns belong to the sets {I:I=1, . . . , k} and {J:J=1, 1. . . , } respectively. Whenever appropriate, I and J would be used as shorthand to mean pᵢ=I and γⱼ=J respectively. Now, consider a mixture model given by

$$\begin{matrix}p ( {y}_{{i}_{j}} ) = {\sum }_{I , J}^{ } p ( I , J ) p ( {y}_{ij} \backslash I , J ) \\ = {\sum }_{I , J}^{ } {π}_{I , J f ψ} ( {y}_{ij} ; {θ}_{i , j , I , J} )\end{matrix} \qquad ( 2 )$$

where π_{IJ} denotes the prior probabilities associated with the latent variable pair (I, J) and θ_{i,j,I,J} is the corresponding natural parameter that could have additive structural constraints, e.g., θ_{i,j,I,J}=θᵢ+θⱼ+θ_{I,J} (accommodates row, column and co-cluster interactions) or θ_{i,j,I,J}=θ_{I,J} (accommodates only co-cluster interactions). Using the bi-jection result between (regular) exponential families and a special class of Bregman divergences [1] and the projection theorem characterizing the optimality of minimum Bregman information matrix with respect to generalized additive models in the natural parameter space [3], it can be shown that maximizing the log-likelihood of Y with respect to the appropriate choice of the mixture model eq. 2 is analogous to minimizing the reconstruction error in the Bregman co-clustering framework. The mixture model, in general, results in soft cluster assignments and is exactly equivalent to the “hard” Bregman co-clustering formulation when the dispersion of the mixture components is assumed to be zero.

We note that conditional on the latent variables pᵢ, γⱼ, the mixture model in eq. 2 captures interactions through the block means; the main issue is to find an optimal clustering to adequately explain the local structure in our data. (Henceforth, we refer to each mixture component as a block to maintain the analogy with the hard assignment case.) Also, omitting covariates may provide clusters that contain redundant information and inferior predictive performance; hence, the need to simultaneously adjust both for covariates and find an optimal clustering.

### 3. Squashed Matrix Factorization (SMF)

Related methods corresponding to a predictive discrete latent factor (PDLF) model are discussed in U.S. patent application Ser. No. 11/841,093. Estimating the Δ parameters in the PDLF model is often intractable for large values of k and l, especially when the data is sparse, since one may end up with several co-cluster blocks with no observations. For these blocks, the unknown block-specific parameters are not estimable in the case of hard PDLF model. To overcome this difficulty, we replace the block parameters corresponding to the empty co-clusters by the global mean computed from the residuals of other co-clusters. Such heuristic strategies only partially address the sparsity issue and often lead to poor performance when k and l take large values. One possible approach is to abandon discrete latent factors as in PDLF and instead model the interactions in terms of continuous latent factors via a factorization approach, i.e., assume g(E(yᵢⱼ))=β^{t}xᵢⱼ+Uᵢ^{t}Vⱼ, where Uᵢ and Vⱼ are r dimensional row and column latent factors respectively attached to the i^{th} row and j^{th} column. Such a parameterization captures interactions via the inner product of the row and column projections in an r-dimensional sub-space.

A major question in this context is about the optimal choice of r to minimize predictive error. In the absence of any missing entries, the rank of the dyadic matrix is the best choice. However, when only a small fraction of entries are observed, increasing r provides a good fit to the training data but degrades predictive performance on dyads with missing entries; small values of r on the other hand might fail to adequately account for global structure. For instance, rows (columns) for which we obtain only a handful of observations on column (row) interactions might support a small value of r while those for which the observations on interactions is nearly complete might have enough structure to support larger values of r. A possible remedy to this problem is to use a large value of r accompanied with regularization on the factors Uᵢ and Vⱼ. This is similar to the strategy used for instance in maximum margin matrix factorization (MMMF) algorithm [5,6] where the factors are regularized by imposing a penalty in terms of the Frobenius norm. However, these methods are not scalable unless r is chosen to be extremely small.

The disclosed Squashed Matrix Factorization (SMF) approach can be considered as a two-stage hybrid of discrete and continuous latent factor models that combine the best of both low rank factorization and PDLF. We use PDLF to combat high dimensionality and sparseness, but use moderately large values of k and l to capture structure that maybe present in the dyadic matrix of response by performing factorization on the unknown, but dense matrix A into low rank matrices U and V. Another key feature of SMF is regularization via priors on U, V that allows modeling of extremely sparse/incomplete data.

### 3.1. Detailed Model Description for SMF

As in the case of PDLF, let ρᵢ and γᵢ be random variables attached to the i^{th} row and j^{th} column respectively, indicating row and column cluster memberships respectively. Thus, ρ_{i,} γⱼ) take values in the set {(I, J):(I, J)∈{1, . . . , k}×{1, . . . , l}} and δ_{IJ} denotes the unknown mean corresponding to block (I, J). Then, conditional on (ρ_{i,} γⱼ), we assume that g(μᵢⱼ)=δ_{ρ}_{ᵢ}_{y}_{ⱼ} where μᵢⱼ=E[yᵢⱼ|ρᵢγⱼ], thus, giving rise to kl parameters to be estimated.

For large values of k and l and sparse response, several of these co-clusters could be “empty” (all dyads in the block have wᵢⱼ=0) or have small number of observations leading to high variance estimates. Hence, one is forced to use small values of k and l which often fails to account for global structure in the data appropriately. To combat problems of high variance associated with large number of clusters and high bias for small number of clusters, we take recourse to low rank factorization on the co-cluster means, i.e., we assume δ_{IJ}=U′_{I}V_{J} where U_{I} and V_{J} are r-dimensional latent factors attached to the I^{th} row cluster and J^{th} column cluster. However, note that the δ_{IJ}'s get estimated with varying degrees of accuracy (depending on the number of observations in the co-clusters) and hence although r is the global rank of δ matrix in the latent space, it is not so in the estimation process where uncertainty associated with δ_{IJ} estimates matter in the choice of r.

Thus, rows (or columns) with high uncertainty might support lower values of r while those with more precise estimates may require larger values of r to capture structure appropriately. To balance this bias-variance tradeoff, we allow for large values of r but regularize the factors U_{I} and V_{J} using a prior (norm constraint).

Specifically,

$$[ Y \vert W , ρ , γ , U , V , X , β , φ ] = {\prod }_{ij \text{:} {w}_{ij} = 1}^{ } ⌊ {y}_{ij} \vert {ρ}_{i ,} {γ}_{j ,} U , V , β , {x}_{ij ,} φ ] \\ ⌊ {y}_{ij} \vert {ρ}_{i} , {γ}_{j} U , V , β , {x}_{ij ,} φ ⌋ \sim {f}_{Ψ} ( {y}_{ij} ; g ( {μ}_{ij} ) = {β}^{t} {x}_{ij} + {U}_{ρ i}^{t} {V}_{γ j ,} φ ) , \qquad ( 3 )$$

where fψ, g(·) and φ refer to an exponential family distribution, link function and scaling parameter as in previous sections.

The elements of matrix factors U, V are assumed to have Gaussian zero-mean priors, i.e.,

U_{Is}˜N(0,τ_{U}²);∀[I]₁^{k},∀[s]₁^{r}, V_{Js}˜N(0,τ_{V}²);∀[J]₁^{l},∀[s]₁^{r}, (4)

We note two extreme cases of SMF model described in the equation (5.11), which would be used for comparison. The first corresponds to the case where k=m, l=n and gives rise to a pure factorization model without any clustering, we shall refer to this as regularized weighted low rank factorization (RWF). The second corresponds to a no-factorization model where r=min(k,l), i.e., δ_{IJ} are unconstrained parameters, which is identical to the PDLF model.

### 3.2. Fitting Algorithm for SMF-Gaussian Model

For the sake of illustration, we will confine the rest of our analysis on the SMF approach to the case where the parametric distribution f_{ψ} is Gaussian and the link function g(·) is identity. A similar analysis can be performed for the other exponential family distributions and link functions, i.e., essentially, the entire class of generalized linear models. We now present a generalized EM algorithm to fit the mixture model described in eqs. 3-4 for this simpler case. For the ensuing discussion, we assume that τ_{U}² and τ_{V}² are known. The incomplete data log-likelihood, in this case, after taking into account the priors on U, V is given by

$$\begin{matrix}\begin{matrix}L ( Π , U , V , φ = {σ}^{2} ) = {\sum }_{i , j}^{ } {w}_{ij} log ( p ( {y}_{ij} ) ) + \\ log ( {p}_{U}^{O} ) + log ( {p}_{V}^{O} ) \\ = {\sum }_{i , j}^{ } {w}_{ij} log ( {\sum }_{I , J} {π}_{IJ} N ( \begin{matrix}{y}_{ij} ; {β}^{t} {x}_{ij} + \\ {U}_{I}^{t} {V}_{J} {σ}^{2}\end{matrix} ) ) + \\ log ( {p}_{U}^{O} ) + log ( {p}_{V}^{O} ) ,\end{matrix} \\ where & ( 5 ) \\ \begin{matrix}log ( {p}_{U}^{O} ) = \frac{1}{2 {τ}_{U}^{2}} {‖ U ‖}_{F}^{2} + constant , log ( {p}_{V}^{O} ) \\ = - \frac{1}{2 {τ}_{V}^{2}} {‖ V ‖}_{F}^{2} + constant , Π = {\{ {\{ {π}_{IJ} \}}_{I = 1}^{k} \}}_{J = 1}^{l}\end{matrix} & ( 6 )\end{matrix}$$

refers to the prior probabilities of the co-clusters, and N(y;μ,σ²) is a normal density with ordinate y, mean μ and variance σ².

Let θ=(Π, β, U, V, σ²) denote the set of all unknown parameters that needs to be estimated by maximizing the likelihood in eq. 6. To achieve this, we follow a generalized EM approach. The free-energy function in this case is given by

$$F ( θ , \tilde{p} ) = {\sum }_{ij} {w}_{ij} {E}_{{\tilde{p}}_{ij}} [ log p ( {y}_{ij} , {p}_{i} , {γ}_{j} ] + log ( {p}_{U}^{O} ) + log ( {p}_{V}^{O} ) + {\sum }_{ij} {w}_{ij} H ( {p}_{\tilde{ij}} ) \qquad ( 7 )$$

As before, we alternately optimize this free energy function over each of the parameters as well as the posterior assignments of the dyads to the co-cluster blocks. Hence, the only step that needs elaboration is the estimation of factors U and V, the other parameters are updated exactly as in PDLF.

Updating U and V. Since each yᵢⱼ has a fractional assignment to co-cluster (I, J) with weight pᵢⱼ^{IJ}, the contribution of U and V to the free-energy function in equation (7) is given by

$$( \frac{- 1}{2 {σ}^{2}} {\sum }_{ij} {w}_{ij} {\sum }_{IJ} {{p}_{ij}^{IJ} ( {y}_{ij} - {β}^{t} {x}_{ij} - {U}_{l}^{t} {V}_{J} )}^{2} ) - \frac{1}{2 {τ}_{U}^{2}} {‖ U ‖}_{F}^{2} - \frac{1}{2 {τ}_{V}^{2}} {‖ V ‖}_{F}^{2} \qquad ( 8 )$$

The first term can be further decomposed as

$$\frac{- 1}{2 {σ}^{2}} ( \begin{matrix}{\sum }_{ij} {w}_{ij} {\sum }_{IJ} {{p}_{ij}^{IJ} ( {y}_{ij} - {β}^{t} {x}_{ij} - {\hat{δ}}_{IJ} )}^{2} + \\ {\sum }_{IJ} {{Z}_{IJ} ( {\hat{δ}}_{IJ} - {U}_{I}^{t} {V}_{J} )}^{2}\end{matrix} ) , \qquad ( 9 )$$

$$where {Z}_{IJ} = {\sum }_{ij} {w}_{ij} {p}_{ij}^{IJ} and {\hat{δ}}_{IJ} = \frac{1}{{Z}_{IJ}} ( {\sum }_{ij} {w}_{ij} {p}_{ij}^{IJ} {y}_{ij} ) .$$

Since {\hat{δ}_{IJ}}_{IJ}'s are independent of U and V, we only need to minimize

$$\frac{1}{2 {σ}^{2}} {\sum }_{IJ} {{Z}_{IJ} ( {\hat{δ}}_{IJ} - {U}_{I}^{t} {V}_{J} )}^{2} + \frac{1}{2 {τ}_{U}^{2}} {‖ U ‖}_{F}^{2} + \frac{1}{2 {τ}_{V}^{2}} {‖ V ‖}_{F}^{2} . \qquad ( 10 )$$

We accomplish this minimization by iteratively solving a set of k row and l column generalized ridge regressions. The I^{th} row ridge regression estimates U_{I} by treating Δ_{I}=[\hat{δ}_{I1}, . . . \hat{δ}_{Il}]^{t} as the response vector, V=[V₁: . . . : Vᵣ]^{t} as the design matrix (consists of the latest estimates of V) with Z_{I}^{d}=diag([Z_{I1}, . . . , Z_{Il}]) being the diagonal weight matrix attached to the response vector. In fact, the solution has a closed form and given by (V^{l}Z_{I}^{d}V+λ_{U}I)⁻¹V^{t}Z_{I}^{d}Δ_{I}, where λ_{U}=σ²/τ_{U}² is the regularization parameter. Similar equations hold for the column regressions with regularization parameter λ_{V}=σ²/τ_{V}². The estimates of τ_{U} and τ_{V} are obtained by cross-validation on a tuning set through a grid search on values of λ_{U} and λ_{U} respectively. Larger values of regularization parameters leads to more “shrinkage” towards zero. The iterative procedure is initialized using estimates of U and V from the previous step after relabeling current row and column cluster indices to match the previous UV^{t} through a sequential greedy search for the best row and column permutations. Updates for the hard assignment case is similar with the pᵢⱼ^{IJ}'s being now binary.

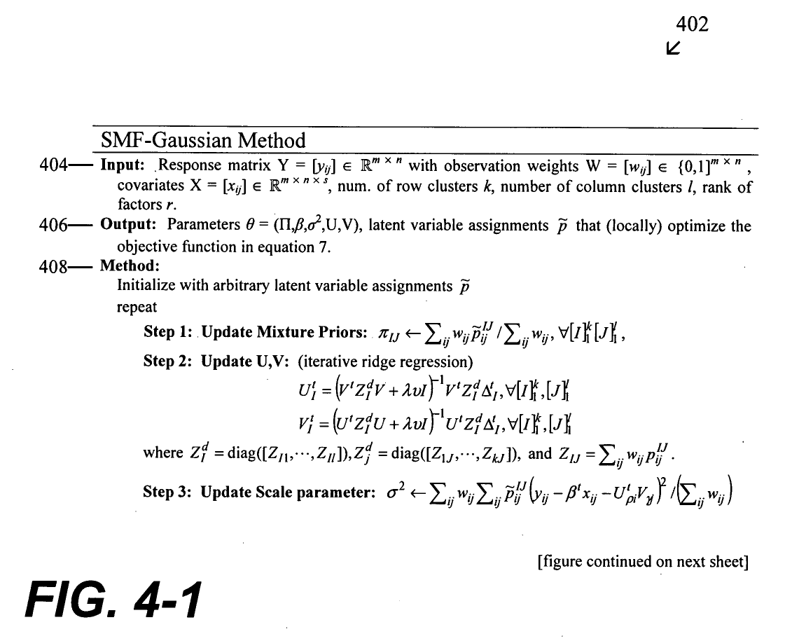

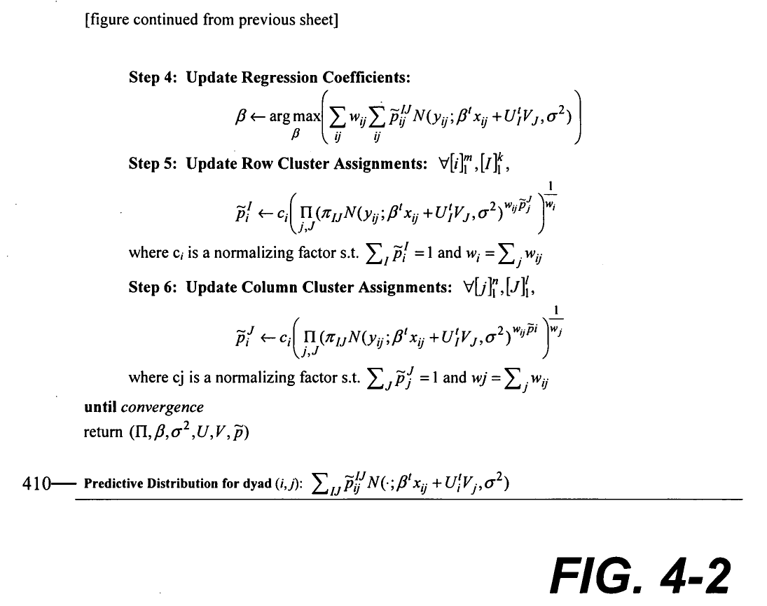

In correspondence to the above discussion, FIG. 4 shows an SMF-Gaussian method 402 for predicting dyadic responses according to an embodiment of the present invention. Input values 404 include the response matrix, observation weights, covariates, number of row clusters, number or column clusters, and the rank of the cluster factors. The output 406 of the method includes parameters that enable a prediction model for the dyad. The steps 408 of the method (which can be carried out iteratively in any order) include: step 1(Updating mixture priors for predicting the response), step 2 (Updating cluster factors U and V), step 3 (Updating a scale parameter for the statistical model, i.e., Gaussian), step 4 (Updating regression coefficients for fitting the measurements to the statistical model), step 5 (Updating row cluster assignments), and step 6 (updating column cluster assignments). When the method terminates (e.g., converges according to some criterion), the parameters are available for evaluating a predictive distribution for the dyad 410.

Computational Complexity. As in the case of PDLF, updates to mixture priors π and the row/column cluster assignments requires a computation time of O(Nkl) where N denotes the number of observations in Y (i.e., elements s.t. wᵢⱼ≠0). The estimation of U, V, on the other hand, requires an iterative procedure with each U (or V) update requiring a computation time of O(klr²). Since the generalized EM algorithm does not require an exact optimization over each argument, it is sufficient to perform a few iterations in each factorization step. Assuming a constant number of iterations, the overall algorithm requires a computation time O(Nkl+klr²), i.e., linear in the number of observations. To accommodate extremely large matrices, which might require large values of k and l, one could further constrain the algorithm to use “hard” instead of “soft” clustering, i.e., each row (column) gets assigned to exactly one cluster (the one with maximum assignment probability) with weight of unity, which is similar in spirit to k-means algorithm. This approximation simplifies the row/column cluster assignments and has complexity O(N(k+l)+klr²).

### 4. Empirical Evaluation of SMF-Gaussian Method

We first describe experiments on simulated data that illustrate the flexibility of the SMF approach followed by results on the MovieLens and ad-click datasets. Since the primary motivation for the SMF approach is to combine the benefits of discrete and continuous latent factor models, we focus specifically on evaluating the performance of the SMF model relative to the state-of-the-art techniques among these two classes, i.e., PDLF/co-clustering (discrete factors) and regularized factorization similar to max-margin factorization (continuous factors). Further, to ensure a fair comparison with the factorization-based techniques that do not accommodate covariates, we only consider special cases of the PDLF and the SMF models that assume no covariate information.

### 4.1. Simulation Example.

Data Generation. We generated a 100×100 response matrix A. Using this matrix as our mean for dyads (i, j), we sampled two realizations from a Gaussian distribution with a given sparsity (i.e., fraction of observed dyads): response matrix B with sparsity 0.4 and response matrix C with sparsity 0.1. The location of dyads with observed entries were selected randomly.

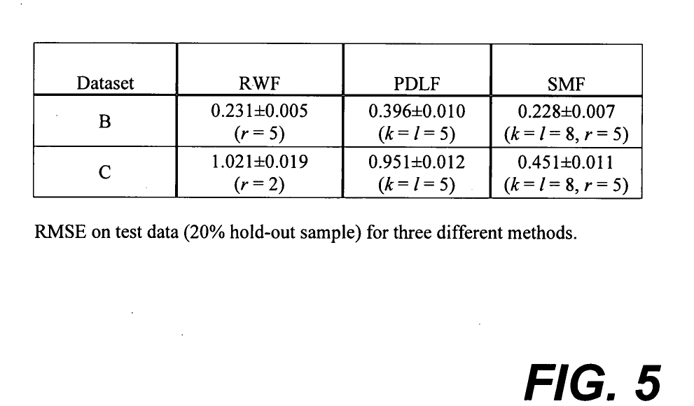

Matrix Reconstruction. We then fitted a pure regularized weighted factorization model (RWF), hard PDLF without covariates(COCLUST) and SMF models to both B and C. In each case, the values of k=l and r were selected by minimizing the predictive error (mean squared error) on a hold-out tuning set. FIG. 5 shows root mean square errors (RMSE) for the three predictive models and the two data sets. In case of the dense sample B, both RWF and SMF provide comparable accuracy and easily out-perform the co-clustering/PDLF approach, which fails to capture the finer interaction structure in the data. However, for the sparse sample C, RWF overfits the data while SMF performs the best proving the effectiveness of bias-variance tradeoff obtained by combining co-clustering with matrix factorization on co-cluster means.

### 4.2. Flexibility of SMF.

Using the MovieLens dataset, we create a Gaussian response from the rating scores by using the transform \sqrt{(6−y)} to reduce the skew in the data. This response was then modeled using SMF (Algorithm 3), RWF and COCLUST with varying choices of number of clusters k ∈ {5,10,15,20,25,30} (l was set to

$$3 k ≃ \frac{kn}{m} )$$

and factor rank r ∈ {1,2,3,5,10}. The optimal choice of k, r, λ_{U} and λ_{V} was selected by cross-validation on a tuning set.

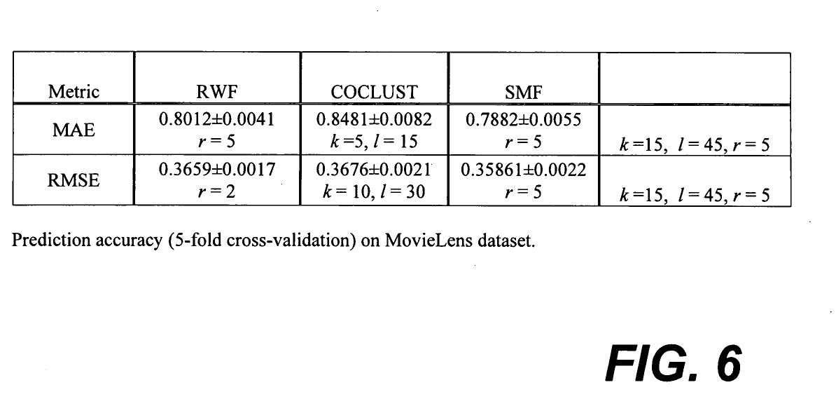

FIG. 6 shows the root mean squared error (RMSE) on the new response as well as the mean absolute error (MAE) (after inverse transformation) on the predictions provided by the various algorithms for optimal choices of k, r. The SMF approach provides better prediction accuracy compared to the others due to greater flexibility which is obtained due to combination of co-clustering with matrix factorization.

### 4.3. Predicting Click Conversion Rates.

To demonstrate the scalability of our approach, we perform a study on modeling click-conversion rates (fraction of the time click on an ad translates to the advertiser's desired outcome) as a function of the publishing web-site and the click-ip (Internet Protocol) using a large real-life dataset consisting of 480 web-sites, 203447 ips and 302600 ip-website dyads. Modeling conversion rates on publishers' websites is important to understand the effectiveness of ad campaigns. However, these conversion rates are typically very low and the dyadic data is highly sparse, which makes predictive modeling challenging. For each dyad, we create a response variable y using the Freeman-Tukey transform to ensure approximate symmetry and distinguish among zero conversions for varying number of clicks [4]:

$$y = \sqrt{\frac{\# conversions}{\# clicks}} + \sqrt{\frac{\# conversions + 1}{\# clicks}} \qquad ( 11 )$$

The Gaussian assumption on this transformed scale is reasonable. The response was further detrended for web-site effects, i.e., row effects.

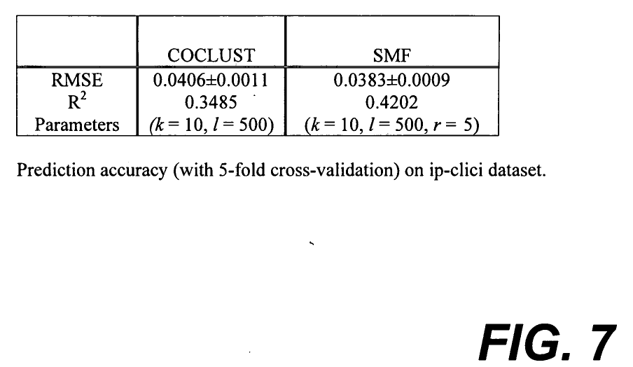

FIG. 7 shows the prediction accuracy (RMSE) obtained using the SMF and COCLUST for the best choice (determined by cross-validation) of k and r where k ∈ {5,10,15,20}, r ∈ {1,2,3,5,10} and l=50k. Due to high sparsity of the response matrix, the RWF approach did not converge except for the case where r was small and the regularization parameters λ_{U}, λ_{V} were chosen to be very large, which resulted in extremely poor performance. Hence, we do not report results using RWF for this experiment.

For reasons of scalability, we used the “hard” co-clustering algorithm. The regularization parameter for SMF was chosen to be 0.3. As in the previous experiments, the results demonstrate the superior predictive power of the proposed SMF approach. In this case SMF demonstrated a 20% relative gain by providing an up to 42% reduction in the squared loss as compared to 35% in case of co-clustering as seen from the R² numbers in FIG. 7, where we have used the formula

R²(model)=1−MSE(model)/MSE(cons tan t model) (12)

At least some values for the results of the above-described methods can be output to a user or saved for subsequent use. For example the prediction parameters can be saved directly for application as in predicting dyadic responses. Alternatively, some derivative or summary form of the results (e.g., averages, interpolations, etc.) can be saved for later use according to the requirements of the operational setting.

### 5. Additional Embodiments

Additional embodiments relate to an apparatus for carrying out any one of the above-described methods, where the apparatus includes a computer for executing computer instructions related to the method. In this context the computer may be a general-purpose computer including, for example, a processor, memory, storage, and input/output devices (e.g., keyboard, display, disk drive, Internet connection, etc.). However, the computer may include circuitry or other specialized hardware for carrying out some or all aspects of the method. In some operational settings, the apparatus may be configured as a system that includes one or more units, each of which is configured to carry out some aspects of the method either in software, in hardware or in some combination thereof. For example, the system may be configured as part of a computer network that includes the Internet. At least some values for the results of the method can be saved for later use in a computer-readable medium, including memory (e.g., RAM (Random Access Memory)) and permanent storage (e.g., a hard-disk system).

Additional embodiments also relate to a computer-readable medium that stores (e.g., tangibly embodies) a computer program for carrying out any one of the above-described methods by means of a computer. The computer program may be written, for example, in a general-purpose programming language (e.g., C, C++) or some specialized application-specific language. The computer program may be stored as an encoded file in some useful format (e.g., binary, ASCII).

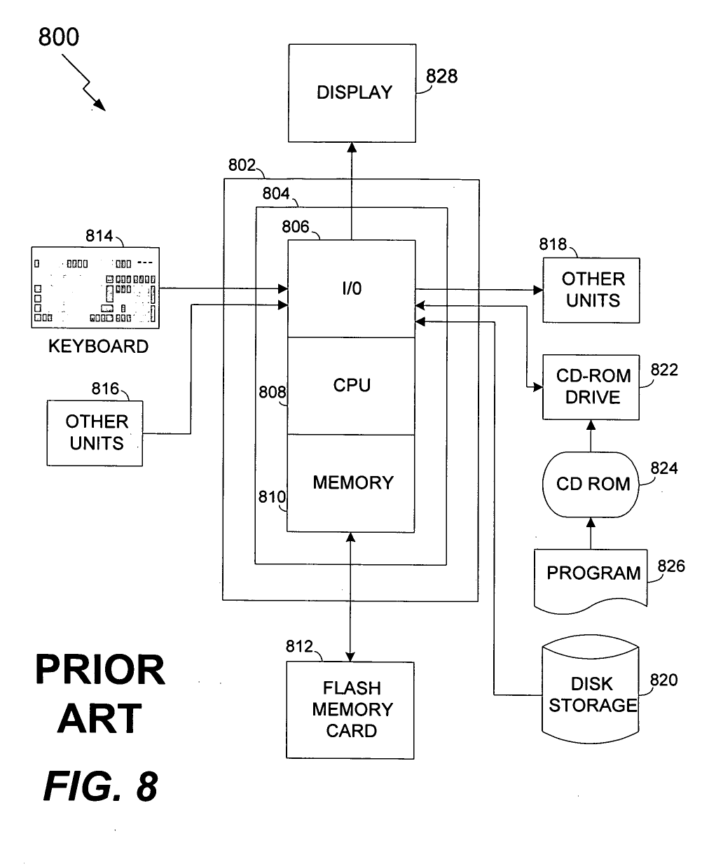

As described above, certain embodiments of the present invention can be implemented using standard computers and networks including the Internet. FIG. 8 shows a conventional general purpose computer 800 with a number of standard components. The main system 802 includes a motherboard 804 having an input/output (I/O) section 806, one or more central processing units (CPU) 808, and a memory section 810, which may have a flash memory card 812 related to it. The I/O section 806 is connected to a display 828, a keyboard 814, other similar general-purpose computer units 816, 818, a disk storage unit 820 and a CD-ROM drive unit 822. The CD-ROM drive unit 822 can read a CD-ROM medium 824 which typically contains programs 826 and other data.

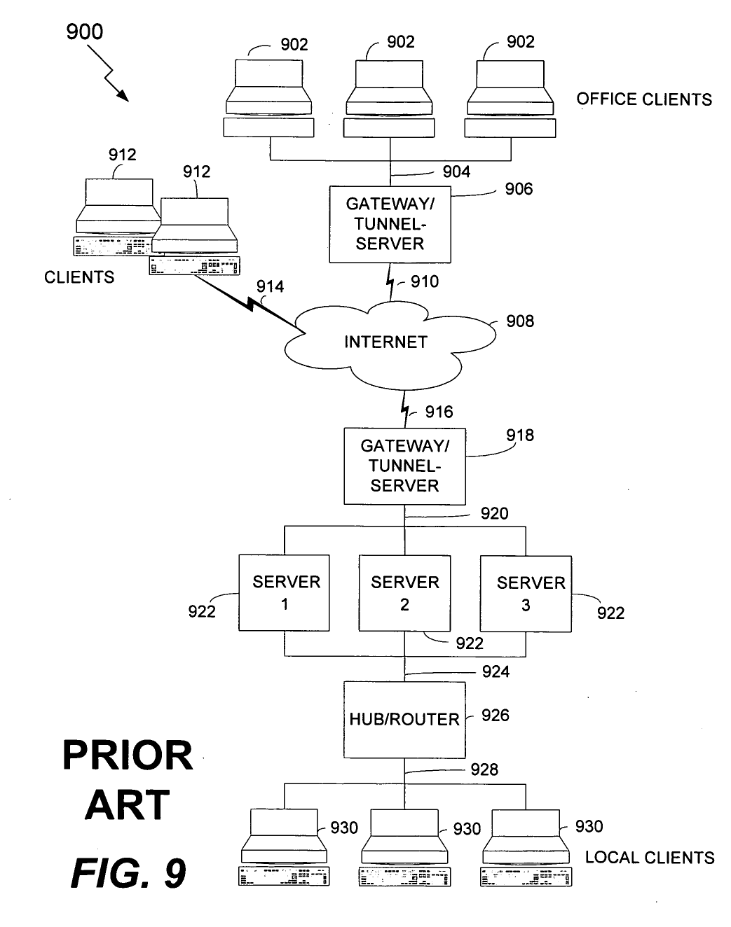

FIG. 9 shows a conventional Internet network configuration 900, where a number of office client machines 902, possibly in a branch office of an enterprise, are shown connected 904 to a gateway/tunnel-server 906 which is itself connected to the Internet 908 via some internet service provider (ISP) connection 910. Also shown are other possible clients 912 similarly connected to the Internet 908 via an ISP connection 914. An additional client configuration is shown for local clients 930 (e.g., in a home office). An ISP connection 916 connects the Internet 908 to a gateway/tunnel-server 918 that is connected 920 to various enterprise application servers 922. These servers 922 are connected 924 to a hub/router 926 that is connected 928 to various local clients 930.

Although only certain exemplary embodiments of this invention have been described in detail above, those skilled in the art will readily appreciate that many modifications are possible in the exemplary embodiments without materially departing from the novel teachings and advantages of this invention. For example, aspects of embodiments disclosed above can be combined in other combinations to form additional embodiments. Accordingly, all such modifications are intended to be included within the scope of this invention.

### 6. REFERENCES

The following references are related to the disclosed subject matter:
[1] BANERJEE, A., MERUGU, S., DHILLON, I., AND GHOSH, J. 2005. Clustering with Bregman divergences. Journal of Machine Learning Research 6, 1705-1749.
[2] MADEIRA, S. C. AND OLIVEIRA, A. L. 2004. Biclustering algorithms for biological data analysis: A survey. IEEE Transactions on Computational Biology and Bioinformatics 1, 1, 24-45.
[3] MERUGU, S. 2006. Distributed Learning Using Generative Models. Ph.D. thesis, Dept. of ECE, Univ. of Texas at Austin.
[4] MOSTELLER, F. AND YOUTZ, C. 1961. Tables of the freeman-tukey transformations for the binomial and poisson distributions. Biometrika 48.3-4, 433-440.
[5] RENNIE, J. AND SREBRO, N. 2005. Fast maximum margin matrix factorization for collaborative prediction. In Proceedings of the 22nd International Conference on Machine Learning (ICML). 713-719.
[6] SREBRO, N., RENNIE, J., AND JAAKKOLA, T. 2005. Maximum-margin matrix factorization. In Proceedings of the 19th Annual Conference on Neural Information Processing Systems (NIPS).

What is claimed is:

1. A method of predicting a response relationship between elements of two sets, comprising:
specifying a response matrix that measures a response relationship between elements of a first set corresponding to rows of the response matrix and a second set corresponding to columns of the response matrix;
specifying covariates that measure additional relationships between elements of the first set and the second set;
specifying observation weights for weighing measurements for elements of the first set and the second set;
specifying a number of row clusters for clustering elements of the first set into row clusters;
specifying a number of column clusters for clustering elements of the second set into column clusters;
specifying a rank for cluster factors that model average interactions between row clusters and column clusters by products of cluster factors;
determining prediction parameters for predicting responses between elements of the first set and the second set by improving a likelihood value that relates the prediction parameters to the response matrix, the covariates, the observation weights, the row clusters and the column clusters, wherein determining the prediction parameters includes:
updating the prediction parameters for fixed assignments of row clusters and column clusters, and
updating assignments for row clusters and column clusters for fixed prediction parameters; and
saving one or more values for the prediction parameters in a computer-readable medium.

2. A method according to claim 1, wherein one of the sets corresponds to consumer choices for goods or services, another of the sets corresponds to individual consumers, and the response matrix corresponds to preferences of the individual consumers for the consumer choices.

3. A method according to claim 1, wherein the observation weights are scaled to indicate a presence or an absence of values for the response matrix for specific combinations of rows and columns of the response matrix.

4. A method according to claim 1, wherein improving the likelihood value corresponds to fitting the parameters to the response matrix through a family of probability distributions for predicting the response matrix.

5. A method according to claim 1, wherein the prediction parameters include mixture prior probabilities for assigning rows and columns to row clusters and column clusters.

6. A method according to claim 1, wherein the prediction parameters include regression coefficients for using combinations of the covariates to predict the response relationship between elements of the two sets.

7. A method according to claim 1, wherein the prediction parameters include row cluster factors and column cluster factors for using products of the row cluster factors and the column cluster factors to predict the response relationship between elements of the two sets.

8. A method according to claim 1, wherein updating assignments for row clusters and column clusters includes calculating probability values for assigning rows and columns by using products of cluster factors to estimate effects of possible assignments.

9. A method according to claim 1, further comprising: using the prediction parameters to predict a likelihood over response values between elements of the two sets.

10. A computer-readable medium that stores a computer program for predicting a response relationship between elements of two sets, wherein the computer program includes instructions for:
specifying a response matrix that measures a response relationship between elements of a first set corresponding to rows of the response matrix and a second set corresponding to columns of the response matrix;
specifying covariates that measure additional relationships between elements of the first set and the second set;
specifying observation weights for weighing measurements for elements of the first set and the second set;
specifying a number of row clusters for clustering elements of the first set into row clusters;
specifying a number of column clusters for clustering elements of the second set into column clusters;
specifying a rank for cluster factors that model average interactions between row clusters and column clusters by products of cluster factors;
determining prediction parameters for predicting responses between elements of the first set and the second set by improving a likelihood value that relates the prediction parameters to the response matrix, the covariates, the observation weights, the row clusters and the column clusters, wherein determining the prediction parameters includes:
updating the prediction parameters for fixed assignments of row clusters and column clusters, and
updating assignments for row clusters and column clusters for fixed prediction parameters; and
saving one or more values for the prediction parameters.

11. A computer-readable medium according to claim 10, wherein one of the sets corresponds to consumer choices for goods or services, another of the sets corresponds to individual consumers, and the response matrix corresponds to preferences of the individual consumers for the consumer choices.

12. A computer-readable medium according to claim 10, wherein the observation weights are scaled to indicate a presence or an absence of values for the response matrix for specific combinations of rows and columns of the response matrix.

13. A computer-readable medium according to claim 10, wherein improving the likelihood value corresponds to fitting the parameters to the response matrix through a family of probability distributions for predicting the response matrix.

14. A computer-readable medium according to claim 10, wherein the prediction parameters include mixture prior probabilities for assigning rows and columns to row clusters and column clusters.

15. A computer-readable medium according to claim 10, wherein the prediction parameters include regression coefficients for using combinations of the covariates to predict the response relationship between elements of the two sets.

16. A computer-readable medium according to claim 10, wherein the prediction parameters include row cluster factors and column cluster factors for using products of the row cluster factors and the column cluster factors to predict the response relationship between elements of the two sets.

17. A computer-readable medium according to claim 10, wherein updating assignments for row clusters and column clusters includes calculating probability values for assigning rows and columns by using products of cluster factors to estimate effects of possible assignments.

18. A computer-readable medium according to claim 10, wherein the computer program further includes instructions for: using the prediction parameters to predict a likelihood over response values between elements of the two sets.

19. An apparatus for predicting a response relationship between elements of two sets, the apparatus comprising a computer for executing computer instructions, wherein the computer includes computer instructions for:
specifying a response matrix that measures a response relationship between elements of a first set corresponding to rows of the response matrix and a second set corresponding to columns of the response matrix;
specifying covariates that measure additional relationships between elements of the first set and the second set;
specifying observation weights for weighing measurements for elements of the first set and the second set;
specifying a number of row clusters for clustering elements of the first set into row clusters;
specifying a number of column clusters for clustering elements of the second set into column clusters;
specifying a rank for cluster factors that model average interactions between row clusters and column clusters by products of cluster factors;
determining prediction parameters for predicting responses between elements of the first set and the second set by improving a likelihood value that relates the prediction parameters to the response matrix, the covariates, the observation weights, the row clusters and the column clusters, wherein determining the prediction parameters includes:
updating the prediction parameters for fixed assignments of row clusters and column clusters, and
updating assignments for row clusters and column clusters for fixed prediction parameters; and
saving one or more values for the prediction parameters.

20. An apparatus according to claim 19, wherein the computer includes a processor with memory for executing at least some of the computer instructions.

21. An apparatus according to claim 19, wherein the computer includes circuitry for executing at least some of the computer instructions.
